(19) United States
(12) Patent Application Publication
(10) Pub. No.: US 2017/0082053 A1
(43) Pub. Date: Mar. 23, 2017

(54) METHOD OF IDENTIFYING A FAULTY FUEL INJECTOR IN AN INTERNAL COMBUSTION ENGINE

(71) Applicant: GM GLOBAL TECHNOLOGY OPERATIONS LLC, Detroit, MI (US)

(72) Inventors: Luca LAURITANO, Turin (IT); Igor PECORARO, Torino (IT)

(73) Assignee: GM GLOBAL TECHNOLOGY OPERATIONS LLC, Detroit, MI (US)

(21) Appl. No.: 15/271,873

(22) Filed: Sep. 21, 2016

(30) Foreign Application Priority Data
Sep. 21, 2015 (GB) 1516667.1

(51) Int. Cl. F02D 41/22; G01P 3/44; F02D 41/26

(52) U.S. Cl. CPC F02D 41/22; F02D 41/26; G01P 3/44; F02D 2041/224

(57) ABSTRACT

A method and apparatus for identifying a faulty fuel injector is disclosed. The fuel injectors are commanded in sequence to inject a fuel quantity. A plurality of values of a crankshaft rotational speed is measured during the combustion of the injected the quantities. The measured values are processed to calculate a respective unbalancing value representative of the fuel quantity injected by the fuel injector. An average value of the calculated unbalancing values is calculated and subtracted from each of the unbalancing values to obtain a respective adjusted unbalancing value. The standard deviation of the adjusted unbalancing values is calculated and multiplied with each of the adjusted unbalancing values to obtain a respective corrected unbalancing value. The corrected unbalancing values are compared with a predetermined threshold value thereof, and a faulty fuel injector is identified if the corresponding corrected unbalancing value exceeds the predetermined threshold value.

### CROSS-REFERENCE TO RELATED APPLICATION

This application claims priority to Great Britain Patent Application No. 1516667.1, filed Sep. 21, 2015, which is incorporated herein by reference in its entirety.

### TECHNICAL FIELD

The present disclosure pertains to a method of identifying a faulty fuel injector in an internal combustion engine.

### BACKGROUND

It is known that internal combustion engines are equipped with fuel injectors, the fuel injectors being used to provide fuel to the cylinders of the engine under control of an Electronic Control Unit (ECU) of the engine. In case of specific mechanical or electrical faults, an injector can remain stuck in a closed position causing a permanent engine vibration and being unable to be controlled. Thus, there is a need to provide a strategy to detect a stuck closed injector due to a mechanical or electrical fault in a fuel injection system of an internal combustion engine, regardless of the fact that the engine is operating in an idle or in a transient condition.

### SUMMARY

An embodiment of the disclosure provides a method of identifying a faulty fuel injector in an internal combustion engine having a plurality of fuel injectors. In accordance with the method, each one of the fuel injectors is commanded in sequence to inject a fuel quantity. During the combustion of the injected fuel quantities, a plurality of values of a crankshaft rotational speed is measured. The measured values of the crankshaft rotational speed are processed to calculate a respective unbalancing value representative of the fuel quantity injected by the fuel injector for each one of the fuel injectors. An average value of the calculated unbalancing values is calculated. The calculated average value is subtracted from each of the unbalancing values to obtain a respective adjusted unbalancing value, for each one of the fuel injectors. The standard deviation of the adjusted unbalancing values is calculated. Each of the adjusted unbalancing values is multiplied by the standard deviation to obtain a respective corrected unbalancing value for each one of the fuel injectors. Each of the corrected unbalancing values is compared with a predetermined threshold value thereof. A faulty fuel injector is identified if the corresponding corrected unbalancing value exceeds the predetermined threshold value.

An effect of this embodiment is that when one injector is in a stuck closed condition, the corrected unbalancing value, as calculated according to the method set forth above, is at least one order of magnitude greater than the unbalancing value as directly calculated from the crankshaft rotational speed signal.

At the same time, when all injectors work correctly, the corrected unbalancing values as calculated according to the method set forth above are very close to zero. The combination of these facts allow yields a wide margin to discriminate between Worst Performance Acceptable (WPA) and Best Performance Unacceptable (BPU) injectors, consequently leading to a wide margin of choice for the predetermined threshold, significantly reducing calibration efforts.

According to another embodiment of the present disclosure, the predetermined threshold is determined as a function of an engine working point. An effect of this embodiment is that it takes into consideration the different effects of the engine working point on the crankshaft rotational speed signals.

According to another embodiment of the present disclosure, a faulty fuel injector is identified if the corresponding corrected unbalancing value exceeds the predetermined threshold for a predetermined amount of time. An effect of this embodiment is that, by establishing through a calibration process, a predetermined amount of time during which the corrected unbalancing values relative to a given injector continuously exceed the predetermined threshold, it is possible to reduce or eliminate the occurrence of false identifications.

In accordance with another embodiment, the method further provides multiplying each of the corrected unbalancing values by a respective factor to obtain a diagnostic unbalancing value, and identifying a faulty fuel injector if the corresponding diagnostic unbalancing value exceeds the predetermined threshold. An effect of this embodiment is that it allows to make similar all the corrected unbalance values of all injectors in case of regular operation of all injectors, in order to be able to use one single threshold value for the eventual identification of a faulty injector.

Another aspect of the present disclosure provides an apparatus for identifying a faulty fuel injector in an internal combustion engine having a plurality of cylinders. The apparatus is configured to command each one of the fuel injectors to inject a fuel quantity in sequence, measure a plurality of values of a crankshaft rotational speed during the combustion of the injected fuel quantities, process the measured values of the crankshaft rotational speed to calculate a respective unbalancing value representative of the fuel quantity injected by the fuel injector for each one of the fuel injectors, calculate an average value of the calculated unbalancing values, subtract the calculated average value from each of the unbalancing values to obtain a respective adjusted unbalancing value for each one of the fuel injectors, calculate the standard deviation of the adjusted unbalancing values, multiply each of the adjusted unbalancing values by the standard deviation to obtain a respective corrected unbalancing value for each one of the fuel injectors, compare each of the corrected unbalancing values with a predetermined threshold value thereof, and identify a faulty fuel injector if the corresponding corrected unbalancing value exceeds the predetermined threshold value.

An effect of this aspect is similar to the effect allowed by the method, namely that when one injector is in a stuck closed condition, the corrected unbalancing value, calculated in according to the above embodiment, is at least one order of magnitude greater than the unbalancing value as directly calculated from the crankshaft rotational speed signal. At the some time, when all injectors work correctly, the corrected unbalancing values as calculated with the above embodiment are very close to zero. The combination of these facts allow to obtain a wide margin to discriminate between Worst Performance Acceptable (WPA) and Best Performance Unacceptable (BPU) injectors, consequently leading to a wide margin of choice for the predetermined threshold, significantly reducing calibration efforts.

According to another aspect of the present disclosure, the apparatus is further configured to determine the predetermined threshold as a function of an engine working point. An effect of this aspect is that it takes into consideration the different effects of the engine working point on the crankshaft rotational speed signal.

According to another aspect of the present disclosure, the apparatus is further configured to detect an injector's fault condition if a corrected unbalancing value exceeds the predetermined threshold for a predetermined amount of time. An effect of this aspect is that, by establishing through a calibration process, a predetermined amount of time during which the corrected unbalancing values relative to a given injector continuously exceed the predetermined threshold, it is possible to reduce or eliminate the occurrence of false positives.

According to another aspect of the present disclosure, the apparatus is further configured to multiply the corrected unbalancing values for a predetermined factor that is a function of the number cylinders of the engine. An effect of this aspect is that takes into account the different effects of a different number of cylinders in an engine on the crankshaft rotational speed signal that are representative of the injection of fuel into a cylinder by a respective injector.

According to another embodiment of the present disclosure, the apparatus is further configured to multiply each of the corrected unbalancing values by a respective factor to obtain a diagnostic unbalancing value and means for identifying a faulty fuel injector if the corresponding diagnostic unbalancing value exceeds the predetermined threshold. An effect of this aspect is that it makes similar all the corrected unbalance values of all injectors in case of regular operation of all injectors, in order to be able to use one single threshold value for the eventual identification of a faulty injector.

According to an aspect of the present disclosure, the method and apparatus may be enabled in the form of a computer program including a program-code for carrying out the method described above, and in the form of computer program product including the computer program. The computer program product can be embodied as a control apparatus for an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 is a graph schematically representing a procedure for calculating a value representative of the effect on a crankshaft speed signal of fuel combustion into one of the cylinders of the four cylinder engine of FIGS. 1-2;

FIG. 4 is a graph representing the variation of four unbalancing values over time, one for each one of four cylinders of the internal combustion engine of FIGS. 1-2 in a steady state condition of the engine;

FIG. 5 is a graph representing an average of the variation over time of the four unbalancing values of FIG. 4;

FIG. 6 is a graph representing the variation over time of the four unbalancing values of FIG. 4 to which their average has been subtracted to obtain adjusted unbalancing values;

FIG. 7 is a graph representing the variation over time of the standard deviation of the adjusted unbalancing values of FIG. 6;

FIG. 8 is a graph representing the variation over time of corrected unbalancing values obtained by multiplying the unbalancing values of FIG. 6 for their standard deviation;

FIG. 9 is a graph representing the variation of four unbalancing values over time, one for each one of four cylinders of the internal combustion engine of FIGS. 1-2 in a transient condition of the engine;

FIG. 10 is a graph representing an average of the variation over time of the four unbalancing values of FIG. 9;

FIG. 11 is a graph representing the variation over time of the four unbalancing values of FIG. 9 to which their average has been subtracted to obtain adjusted unbalancing values;

FIG. 12 is a graph representing the variation over time of the standard deviation of the adjusted unbalancing values of FIG. 11;

FIG. 13 is a graph representing the variation over time of corrected unbalancing values obtained by multiplying the unbalancing values of FIG. 11 for their standard deviation;

FIG. 14 is a graph representing a statistical distribution of the performance of a sample of injectors as measured according to the prior art;

FIG. 15 is a graph representing a statistical distribution of the performance of a sample of injectors as measured according to an embodiment of the method; and

FIG. 16 is a flowchart representing an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

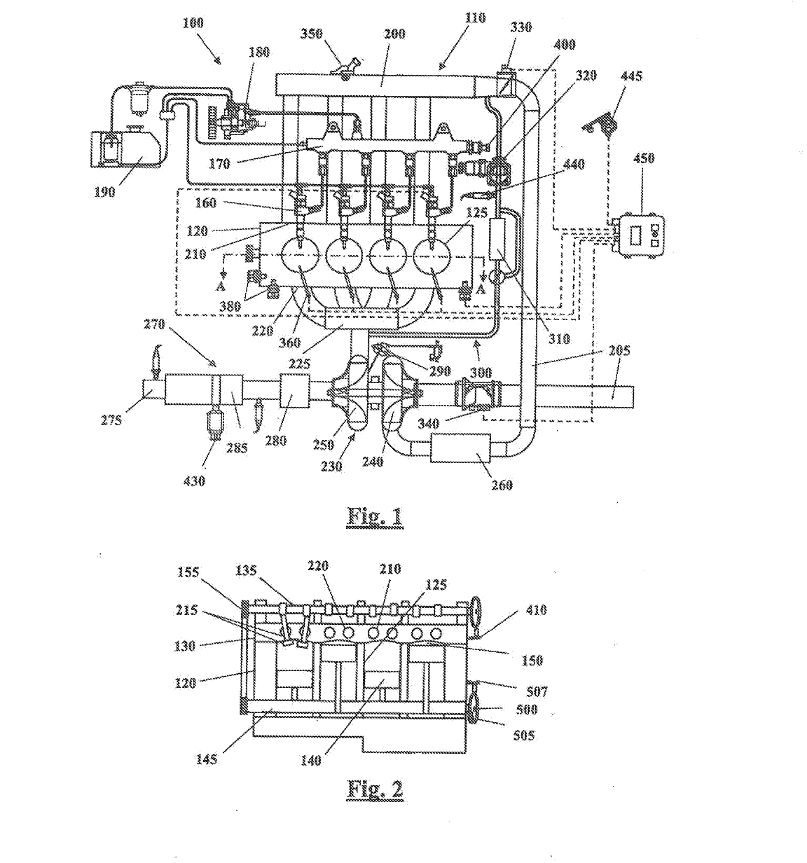

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

A crankshaft position sensor 500 may be provided in order to measure the rotational speed of the crankshaft 145. The crankshaft sensor 500 includes a wheel 505 rotating with the crankshaft 145 and having a plurality of teeth, for example 60 teeth. The crankshaft sensor 500 further includes a stator sensor element 507 which is located in a position close to the periphery of the rotating wheel 505 and that is sensible to the rotation movement of the teeth of the rotating wheel 505. Commonly, a Hall Effect stator sensor may be used, but other detection principles can be employed such as an optical sensor or an inductive sensor. In this way, the stator sensor 507 is able to measure the interval of time between the passage of a teeth and the next one. Such interval of time is conventionally indicated as T6 because the angular distance between the teeth is known and, in case of a sixty teeth wheel is equal to 6° CA (Crank Angle). Since the angular distance between the teeth is constant, the interval of time T6 is thus a direct measure of the rotational speed of the crankshaft 145. As known, the rotational speed of the crankshaft 145 may be influenced by the fuel quantity injected into the cylinders 125 of the engine 110.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an aftertreatment system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The aftertreatment system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOₓ traps, hydrocarbon adsorbers, selective catalytic reduction (SCR) systems, and particulate filters, such as a Selective Catalytic Reduction on Filter (SCRF) or others.

Other embodiments may include a high pressure exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crankshaft position sensor 500, exhaust pressure sensors 430, an EGR temperature sensor 440, and an accelerator pedal position sensor 445.

In particular, a crankshaft position sensor 500 may be provided in order to measure the rotational speed of the crankshaft 145. The crankshaft sensor 500 includes a wheel 505 rotating with the crankshaft 145 and having a plurality of teeth, for example 60 teeth. The crankshaft sensor 500 further includes a stator sensor element 507 which is located in a position close to the periphery of the rotating wheel 505 and that is sensible to the rotation movement of the teeth of the rotating wheel 505. Commonly, a Hall Effect stator sensor may be used, but other detection principles can be employed such as an optical sensor or an inductive sensor. In this way, the stator sensor 507 is able to measure the interval of time between the passage of a teeth and the next one. Such interval of time is conventionally indicated as T6 because the angular distance between the teeth is known and, in case of a sixty teeth wheel is equal to 6° CA (Crank Angle). Since the angular distance between the teeth is constant, each interval of time T6 is thus a direct measure of the rotational speed of the crankshaft 145. As known, the rotational speed of the crankshaft 145 may be influenced by the fuel quantity injected into the cylinders 125 of the engine 110.

Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carry out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

The various embodiments of the method will now be explained considering, as an example, a four cylinder engine, where the cylinders are indicated as A, B, C and D. It should also be noted that the signal provided by the crankshaft sensor 500 is impacted by engine vibrations due to different fuel injected quantity for each cylinder 125, as a consequence of the operations of each injector 160.

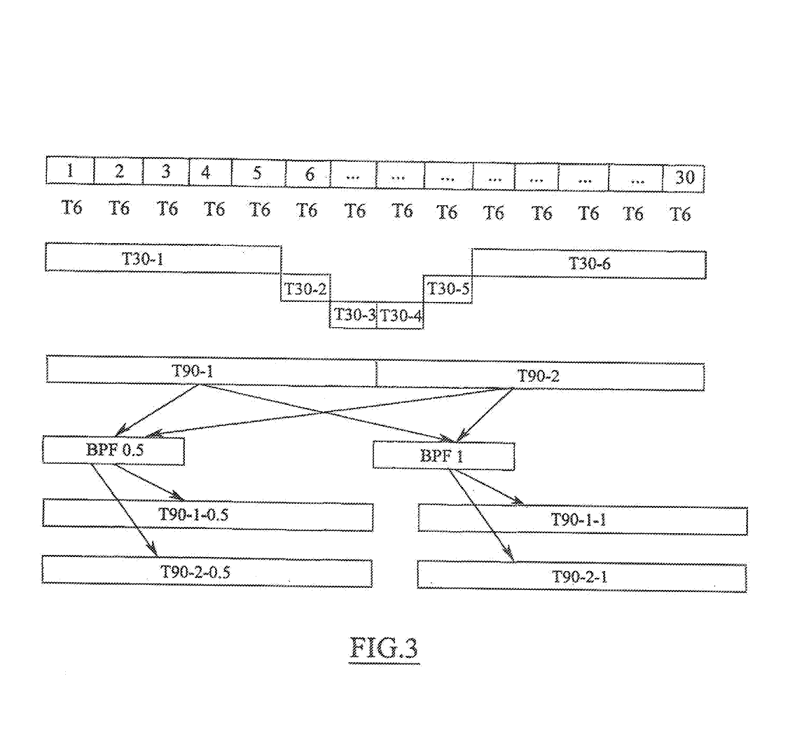

The ECU 450 is able to process the signal provided by the crankshaft sensor 500 and to generate a respective unbalancing value representative of the fuel quantity injected by the fuel injector for each one of the fuel injectors as follows. In particular, FIG. 3 is a graph schematically representing a procedure for calculating a value representative of the effect on a crankshaft speed signal of fuel combustion into one of the cylinders of the four cylinder engine of FIGS. 1-2. In a four cylinder engine every 720° of Crank Angle (CA), the fuel injectors 160 are commanded in sequence to perform a fuel injection, when the corresponding piston is in proximity of its Top Dead Center (TDC) position. As a consequence, in the same 720° of Crank Angle (CA), four combustion occurs, one for each of the four cylinders 125, and each of these fuel injections are scaled by 180° Crank Angle (CA). Hence, over 720° of Crank Angle (CA), the crankshaft sensor 500 generates a signal indicative of the rotational speed of the crankshaft 145, which is affected by all these combustions.

This signal may he processed in the following way in order to extract a numerical value that will be identified hereinafter as unbalancing value that is representative of the effect of the injection of fuel of an injector 160 in a 180° Crank Angle (CA) rotation of the crankshaft.

As mentioned above, considering a crankshaft sensor wheel 505 having sixty teeth, the signal generated by the crankshaft sensor 500 is a sequence of T6 values, each of which represents the time spent by the crankshaft sensor wheel 505 to complete a rotation of 6° CA and thus a direct measurement of the angular speed of the crankshaft sensor wheel 505. The ECU 450 is provided with dedicated software that processes the information coming from each of the 60 teeth of the crankshaft sensor wheel 505 and represented by the T6 periods.

In order to process the crankshaft sensor wheel 505 signal, a window of 180° CA (i.e. 30 T6) is defined for each fuel injector (i), wherein this window corresponds to the expansion stroke of the piston 140 that reciprocates in the cylinder 125 where the fuel injector (i) has performed the fuel injection. For each window of 180° CA, five consecutive values of T6 are summed resulting in a value that is conventionally indicated as T30-1. Since a 180° CA is composed of six 30° CA, five further T30 values, namely T30-2, T30-3, T30-4, T30-5 and T30-6 are calculated by summing the respective five groups of T6 values.

At this point the six T30 are grouped into two groups of consecutive T30 values obtaining two T90 values, namely T90-1 and T90-2, an operation also known in the art as “decimation”. Successively, an anti-aliasing filtering is performed to avoid that frequencies of order greater than the combustion (of order 2 for a four cylinder) be present in the frequency spectra included from order 0 to the order of the combustion (which is 1 in case of a four cylinder engine), in other words to avoid superposition of high frequencies onto the frequencies to be analyzed.

Therefore the T90-1 and T90-2 values are processed by using band pass filters of order 0.5 and 1, indicated respectively as BPF0.5 and BPF1 in FIG. 3. Processing the T90-1 and T90-2 values with the band pass filters of order 0.5 calculates two values namely T90-1-0.5 and T90-2-0.5 and processing the T90-1 and 190-2 values with the band pass filters of order 1 calculates two other values namely T90-1-1 and 190-2-1. These four values are finally inputted into the following formula (1):

Unbalance(i)=(T90-1-0.5+T90-2-0.5)*KA+(T90-1-1+T90-2-1)*KB (1)

where KA and KB are coefficients that are determined for each cylinder 125 by means of a calibration activity.

With the above procedure therefore unbalancing values can be calculated for each cylinder 125 and for each 180° CA rotation. For the purpose of the present description, an unbalancing value referred to an injector 160 is a value representative of a fuel quantity injected by such injector in a given engine cycle. In particular, an unbalancing value is not representative of an absolute injected fuel quantity but of a relative injected fuel quantity with respect to fuel quantity injected by the other fuel injectors. In practical terms, an unbalancing value (i) represents a difference between a fuel quantity injected by injector (i) with respect to the fuel quantity injected by the other injectors.

As a further example, in a case of a three-cylinders engine, a combustion occurs every 240° CA. Therefore by applying the above calculation procedure, two periods of 120° CA, referred to as 1120-1 and 1120-2 are calculated instead of the T90 periods for a four-cylinder engine.

As a further illustrative example, for an eight-cylinders engine a combustion occurs every 45° CA. Therefore by applying the above calculation procedure, two periods of 22.5° CA are calculated for each combustion.

In case of an injector 160 stuck closed due to a fault, the unbalancing values Unbalance (i) are strongly impacted, and an object of the various embodiments is to detect this condition. According to an embodiment of the method, with reference for example to a four cylinder engine, unbalancing values for each of the four injectors A, B, C and D, cylinder, namely Unbalance_A, Unbalance_B, Unbalance_C and Unbalance_D, or in general, Unbalance (i) is calculated by the ECU 450 at each engine cycle as explained above are further processed in the following way.

In a first step, the ECU 450 calculates the average Unbalance Average of all unbalancing values Unbalance (i) for each cylinder A, B, C and D. Mathematically, this step can be expressed by means of the following equation (2):

$$Unbalance Average = \frac{{\sum }_{i}^{N} Unbalance ( i )}{N} \qquad ( 2 )$$

where (i)=A, B, C, D.

In a second step, the ECU 450 subtracts the average Unbalance Average calculated as above, from each of the unbalancing values Unbalance (i) in order to normalize them and to take into account specific injection drift configurations. Namely, in the example above, four adjusted unbalancing values Unbalance_{NoAverage}(i) are calculated using the following equation (3):

Unbalance_{NoAverage}(i)=Unbalance(i)−Unbalance Average (3)

where (i)=A, B, C, D.

Then the ECU 450 calculates the standard deviation Unbalance Standard Deviation of all adjusted unbalancing values Unbalance_{NoAverage} (i), according to the following equation (4):

$$Unbalance Standard Deviation = \sqrt{\frac{{\sum }_{i}^{N} [ {Unbalance}_{NoAverage} ( i ) - \frac{{\sum }_{i}^{N} {Unbalancee}_{NoAverage} ( i )}{N} ]}{N}} \qquad ( 4 )$$

where (i)=A, B, C, D.

It is worthwhile to note that when one injector 160 is in a non-operating condition, namely a stuck closed condition, the standard deviation Unbalance Standard Deviation of the adjusted unbalancing values increases significantly.

In a further step of the method, the ECU 450 multiplies all the adjusted unbalancing values Unbalance_{NoAverage}(i) by the calculated standard deviation Unbalance Standard Deviation of all adjusted unbalancing values, to determine corrected unbalancing values Corrected Unbalance(i), according to the following equation (5):

Corrected Unbalance(i)=Unbalance_{NoAverage}(i)·Unbalance Standard Deviation (5)

where (i) A, B, C, D.

The above operation is particularly useful in order to amplify the unbalancing values in case of faulty injector due to higher standard deviation, and reduce the unbalancing values when all injectors are working properly due to lower standard deviation.

It is also worthwhile to note that, when one injector is non-operating or stuck closed, the corrected unbalancing values may be of one order of magnitude greater than those of the original unbalancing values Unbalance (i). On the contrary, when all injectors 160 work correctly, the corrected unbalancing values Corrected Unbalance(i), as calculated above, may be very close to zero.

This fact yields a high separation between Worst Performance Acceptable (WPA) and Best Performance Unacceptable (BPU) injectors, a condition that provides the benefit of a wide margin to choose a value for a threshold that distinguishes a fault condition of the injector 160 from normal condition thereof.

Once the corrected unbalancing values Corrected Unbalance(i) have been determined by the above calculations, the ECU 450 compares all corrected unbalancing values Corrected Unbalance(i) to a predetermined threshold Diagnostic Threshold to distinguish a faulty condition from a normal condition of the injector 160.

The predetermined threshold Diagnostic Threshold may be a function of an engine working point, expressed for example in terms of engine speed and engine load, as stated in the following equation (6):

Diagnostic Threshold=(Engine Working Point) (6)

As stated above, the predetermined threshold Diagnostic Threshold depends upon the engine working point and has, generally, a higher value for high values of engine speed and engine load and a low value for low values of engine speed and engine load.

If a corrected unbalancing value Corrected Unbalance(i) exceeds the predetermined threshold Diagnostic Threshold, a corresponding faulty injector may be identified.

As a refinement of the method, a faulty injector may be identified if the corrected unbalancing value Corrected Unbalance(i) exceeds the predetermined threshold Diagnostic Threshold for a calibratable amount of time.

In a preferred embodiment of the method, the ECU 450 also multiplies each corrected unbalancing values Corrected Unbalance(i) by a specific factor K(i) that depends on the number of cylinders 125 of the engine 110, according to the following equation (7):

Diagnostic Unbalance(i)=Corrected Unbalance(i)·K(i) (7)

where (i)=A, B, C, D and K(i) is the multiplicative factor that depends on the number of cylinders 125 of the engine 110.

It must be noted that the K(i) factors may be introduced in case in which it is verified experimentally that the corrected unbalance value of an injector (i) are significantly different from the corrected unbalance values of the other injectors even when injector (i) is working properly. In this case, the K(i) factors are introduced to make similar all the corrected unbalance values of all injectors in case of regular operation of all injectors, in order to be able to use one single threshold value for the comparison. Experimentally it has been noted that the K(i) factors are not normally useful for a four-cylinders engine, but may be required for other engines, for example for three-cylinders engines. In this case, a faulty injector may be identified if the corresponding diagnostic unbalancing values Diagnostic Unbalance(i) (instead of the corrected unbalancing values Corrected Unbalance(i) mentioned before) exceed the predetermined threshold Diagnostic Threshold.

Also, in this case as a refinement of the method, a faulty injector may be identified if the diagnostic unbalancing values Diagnostic Unbalance(i) exceeds the predetermined threshold Diagnostic Threshold for a calibratable amount of time. In any case that a faulty injector is detected, a Diagnostic Trouble Code (DTC) may be set. For each cylinder a different DTC code may be set.

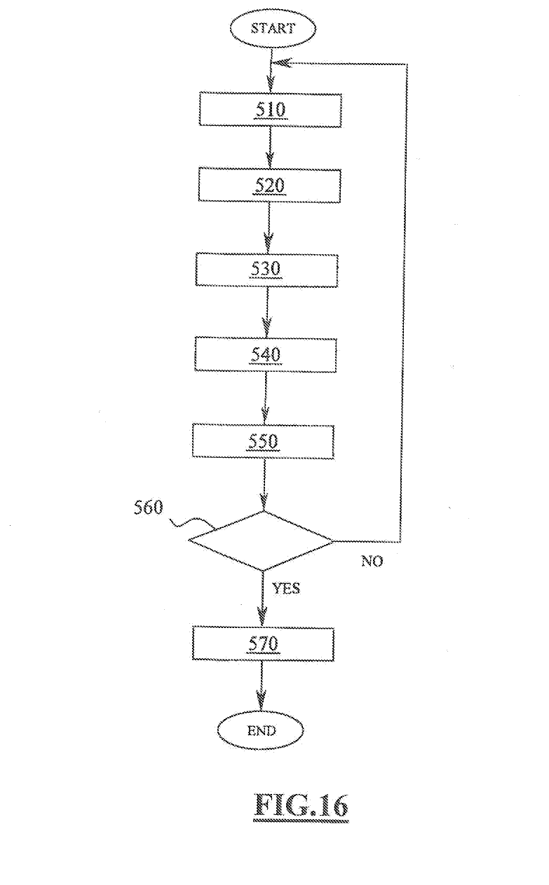

FIG. 16 is a flowchart representing an embodiment of the present disclosure, as performed by the ECU 450 during normal operations of the automotive system 100. A first step of the method provides for measuring the crankshaft rotational speed signal representative of the effect of each injector 160 injecting fuel into the respective cylinder 125 and processes such signal in order to obtain the unbalancing values Unbalance (i) for each cylinder A, B, C and D (block 510). Then the ECU 450 calculates an average value of all unbalancing values Unbalance (i) values (block 520).

In a subsequent step, the ECU 450 subtracts the calculated average value from each of the unbalancing values to obtain adjusted unbalancing values Unbalance_{NoAverage}(i) (block 530). Then the ECU 450 calculates the standard deviation of the adjusted unbalancing values Unbalance_{NoAverage}(i) (block 540). Each of the adjusted unbalancing values Unbalance_{NoAverage}(i) is then multiplied for the standard deviation to obtain corrected unbalancing values (block 550).

A check is then made by comparing each of the corrected unbalancing values with a predetermined threshold thereof (block 560) and, if a corrected unbalancing value exceeds the predetermined threshold, a fault condition of the corresponding injector is identified (block 570). If none of the corrected unbalancing values exceeds the predetermined threshold, the method is repeated starting from the measure of the crankshaft rotational speed signal (block 510).

In order to demonstrate the efficacy of the various embodiments of the method, several tests have been performed on the engine 110, wherein in each test the operations of each injector A, B, C and D is interrupted, one injector at a time, for a certain period.

In a first test, data have been obtained with the engine 110 operating in a steady state condition and elaborated according to an embodiment of the method (FIGS. 4-8). In particular, FIGS. 4-8 represent various steps of the method, starting from the curves represented in FIG. 4 which are determined using the crankshaft sensor 500 detecting variations in the rotational speed of the crankshaft 145 as an effect of fuel injection in the cylinders 125 by the respective injector 160.

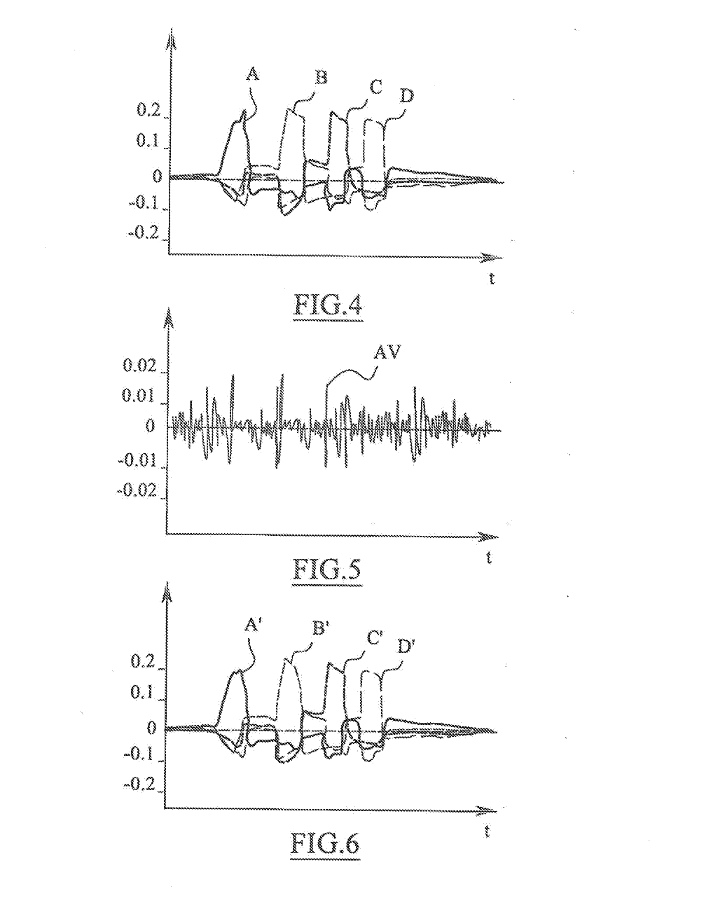

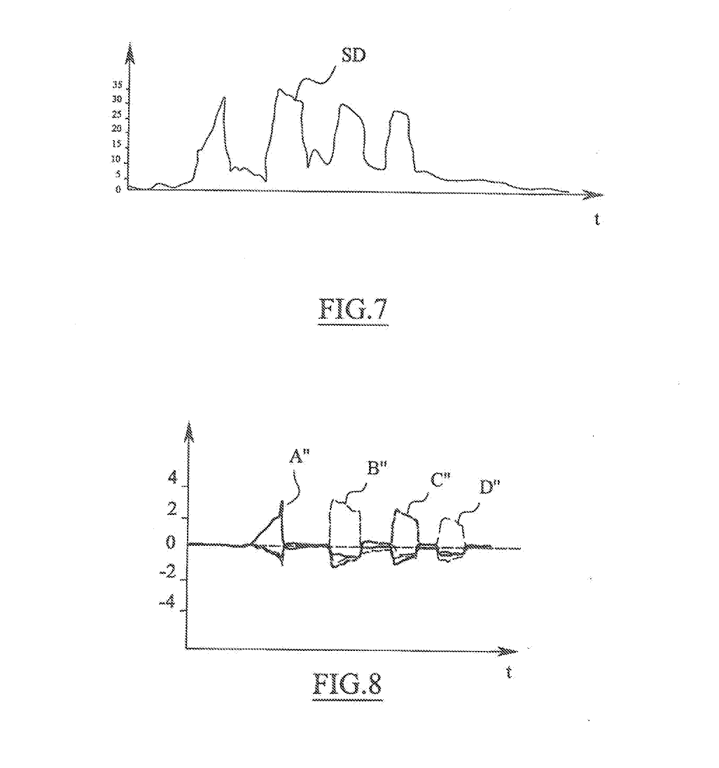

Since the graph of FIG. 4 is created by interrupting sequentially the operations of each of the four injectors A, B, C and D, four different curves are determined, and in the calculations of the various embodiments of the method such curves are composed of a plurality of unbalancing values varying over time and indicated, as above, Unbalance A, Unbalance B, Unbalance C and Unbalance D, or in general, Unbalance (i). In particular, a graph of the average Unbalance Average of the four unbalancing values curves Unbalance (i) of FIG. 4 is represented in FIG. 5 (for simplicity indicated as AV in FIG. 5). A graph of the four unbalancing values curves Unbalance (i) to which their average has been subtracted, namely of the adjusted unbalancing values Unbalance_{NoAverage}(i), is represented in FIG. 6 (for simplicity indicated as A′, B′, C′ and D′ in FIG. 6). A graph of the standard deviation of the adjusted unbalancing values is represented in FIG. 7 (for simplicity indicated as SD in FIG. 7). A graph representing the adjusted unbalancing values multiplied by the standard deviation is represented in FIG. 8 (for simplicity indicated as A″, B″, C″ and D″ in FIG. 8).

The graph of FIG. 8 makes it clear that, when one injector is non-operating or stuck closed, the corrected unbalancing values are one order of magnitude greater than those of the original unbalancing values of FIG. 4 and that, when all injectors 160 work correctly, the corrected unbalancing values Corrected Unbalance(i) are very close to zero. In any case, all numerical values are merely exemplary and may vary depending on different automotive systems 100.

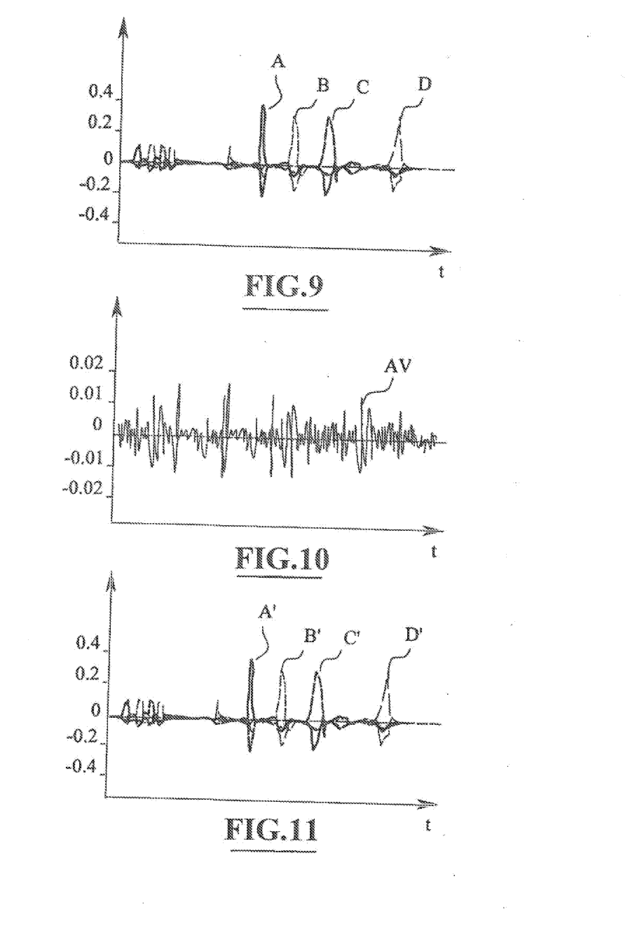

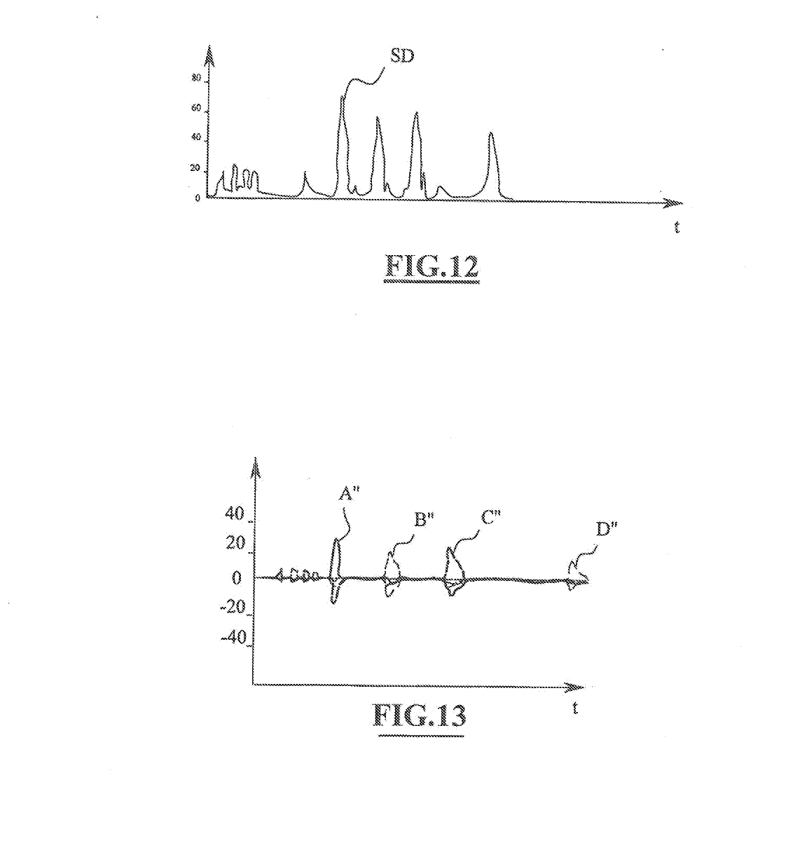

A second test has been performed as detailed in FIGS. 9-12 which represent various step of an embodiment of the method, starting from the curves represented in FIG. 9 which are determined using the crankshaft sensor 500 detecting variations in the rotational speed of the crankshaft 145 in a transient condition of the engine 110. Also in this case, the operations of each injector A, B, C and D is interrupted, one injector at a time, for a certain period. In particular, FIG. 9 is a graph representing four unbalancing values over time, one for each one of the four injectors A, B, C and D of an internal combustion engine 110 in a transient condition of the engine. FIG. 10 is a graph representing an average AV of the four unbalancing values of FIG. 9 as calculated by applying Equation (2) above and FIG. 10 is a graph representing the curves of FIG. 8 to which their average has been subtracted, as calculated by applying Equation (3) above and represented in FIG. 11 as curves A′, B′, C′ and D′. As in the example above, the standard deviation Unbalance Standard Deviation of all adjusted unbalancing values Unbalance_{NoAverage}(i) is calculated, according to equation (4) as also represented in the graph of FIG. 12 with the curve SD. Finally, also in this example, the adjusted unbalancing values Unbalance_{NoAverage}(i) are multiplied by the calculated standard deviation Unbalance Standard Deviation of all adjusted unbalancing values, to determine corrected unbalancing values Corrected Unbalance(i), according to equation (5) above and the result is represented in FIG. 13 as curves A″, B″, C″ and D″.

Moreover, the graph of FIG. 13 makes it clear that, when one injector is non-operating or stuck closed, the corrected unbalancing values are of one order of magnitude greater, or even more than those of the original unbalancing values of FIG. 8 and that, when all injectors 160 work correctly, the amplitudes of the corrected unbalancing values Corrected Unbalance(i) are very close to zero.

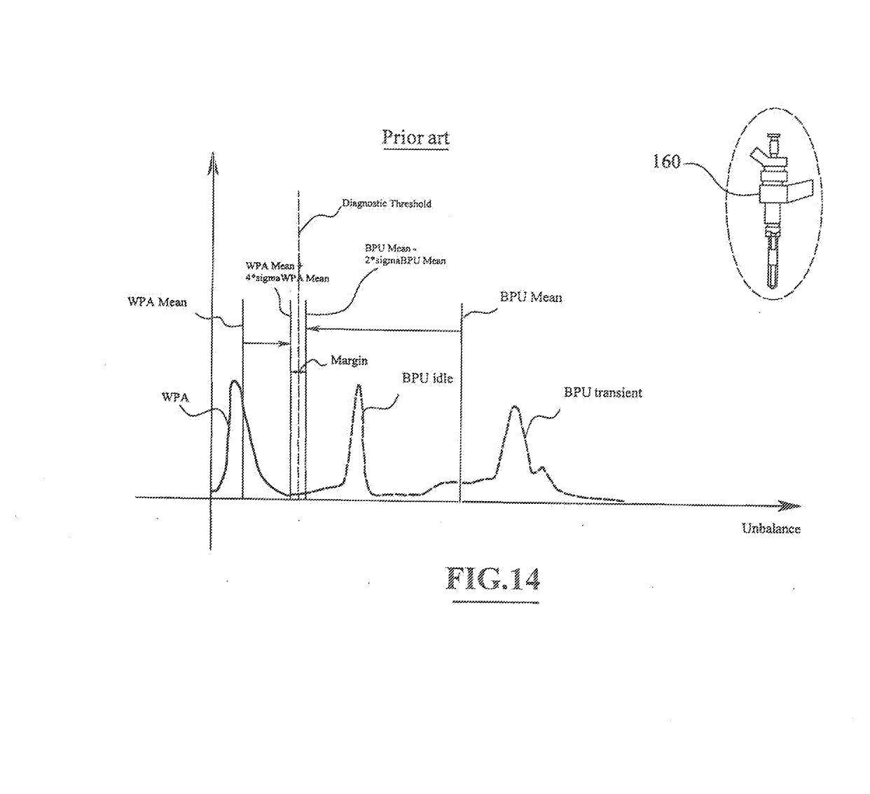

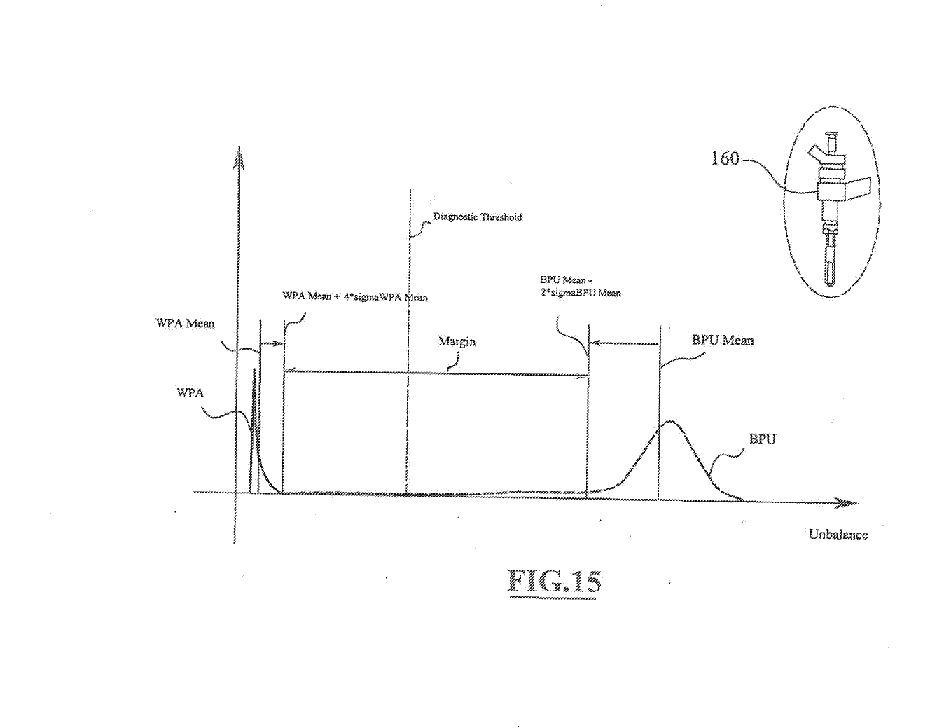

In order to better explain the advantages of the various embodiments of the present disclosure, reference is now made to FIG. 14, namely a graph representing a statistical distribution of the performance of a sample of injectors 160, as measured according to a method of the prior an In the statistical distribution of FIG. 14, the injectors 160 tested with the method of the prior art can be classified in two groups: the first group gives rise to the distribution on the left side of the graph (continuous line) and is represented by all those injectors whose performance is in the range of Worst Performance Acceptable (WPA), while the second group gives rise to the distribution on the right side of the graph (dotted line) and is represented by all the Best Performance Unacceptable (BPU) injectors.

While the distribution of the Worst Performance Acceptable (WPA) injectors has only one peak, the distribution of the Best Performance Unacceptable (BPU) injectors has two peaks, one peak for injectors tested in idle conditions of the engine and another peak for the Injectors tested in a transient conditions of the engine.

This has the consequence that the distribution of the Worst Performance Acceptable (WPA) injectors, with mean equal to WPAmean, has a relatively small standard deviation sigmaWPA, but the distribution of the Best Performance Unacceptable (BPU) injectors, with mean equal to BPUmean, has a relatively large standard deviation sigmaBPU due to the peculiar two-peaks statistical distribution of FIG. 14.

A six sigma separation between the Worst Performance Acceptable (WPA) injectors and the Best Performance Unacceptable (BPU) injectors indicates a condition to be satisfied in order for a faulty fuel injector detecting method of detecting to be sufficiently discriminating in between WPA and BPU injectors. This condition can also be expressed in mathematical terms as follows:

WPAmean+4*sigmaWPA+2*sigmaBPU<BPUmean

It can be seen from FIG. 14 that the prior art method satisfies this condition, but only in virtue of a very small margin, therefore requesting a very high calibration effort to define the diagnostic threshold to detect a stuck closed injector, because the diagnostic threshold must be set within the margin in order to distinguish between WPA and BPU injectors. This small margin of calibration may also lead to possible misdetection or false positives.

FIG. 15 is a graph representing a statistical distribution of the performance of a sample of injectors as measured according to an embodiment of the method. In the statistical distribution of FIG. 15, the injectors 160 tested with the method according to the various embodiments of the present disclosure can still be classified in the same two groups, namely the WPA injectors and the BPU injectors, but both distributions have a relatively small standard deviation and their respective means, namely WPAmean and BPUmean are widely separated. This has the consequence that, not only the method according to the various embodiments of the present disclosure satisfied the condition:

WPAmean+4*sigmaWPA2*sigmaBPU<BPUmean

but a very wide margin is left available to choose the predetermined threshold Diagnostic Threshold preferred value, leading to an easy calibration effort.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-9. (canceled)

10. A method of identifying a faulty fuel injector in an internal combustion engine having a plurality of fuel injectors, the method comprising:
commanding in sequence each one of the fuel injectors to inject a fuel quantity;
measuring a plurality of values of a crankshaft rotational speed during the combustion of the injected fuel quantities;
processing the measured values of the crankshaft rotational speed, for each one of the fuel injectors, to calculate a respective unbalancing value representative of the fuel quantity injected by each fuel injector;
calculating an average value of the calculated unbalancing values;
subtracting the calculated average value from the unbalancing values for each one of the fuel injectors to obtain a respective adjusted unbalancing value;
calculating the standard deviation of the adjusted unbalancing value for each one of the fuel injectors;
multiplying each of the adjusted unbalancing values by the standard deviation for each one of the fuel injectors to obtain a respective corrected unbalancing value;
comparing each of the corrected unbalancing values with a predetermined threshold value thereof; and
identifying a faulty fuel injector when the corresponding corrected unbalancing value exceeds the predetermined threshold value.

11. The method according to claim 10, further comprising determining the predetermined threshold as a function of an engine working point.

12. The method according to claim 10, wherein further comprising identifying a faulty fuel injector when the corresponding corrected unbalancing value exceeds the predetermined threshold for a predetermined amount of time.

13. The method according to claim 10, comprising:
multiplying each of the corrected unbalancing values by a respective factor to obtain a diagnostic unbalancing value; and
identifying a faulty fuel injector when the corresponding diagnostic unbalancing value exceeds the predetermined threshold.

14. A non-transitory computer readable medium comprising a computer program including a computer-code suitable for performing the method according to claim 10.

15. A control apparatus for an internal combustion engine to identify a faulty fuel injector in an internal combustion engine having a plurality of fuel injectors, the control apparatus comprising:
an electronic control unit;
a non-transitory machine readable data carrier associated to the electronic control unit and a computer program stored in the data carrier, which when executed on the electronic control unit, is configured to:
command in sequence each one of the fuel injectors to inject a fuel quantity,
measure a plurality of values of a crankshaft rotational speed during the combustion of the injected fuel quantities;
process the measured values of the crankshaft rotational speed to calculate a respective unbalancing value for each one of the fuel injectors representative of the fuel quantity injected by the fuel injector;
calculate an average value of the calculated unbalancing values;
subtract the calculated average value from each of the unbalancing values to obtain a respective adjusted unbalancing value for each one of the fuel injectors;
calculate the standard deviation of the adjusted unbalancing values;
multiply each of the adjusted unbalancing values by the standard deviation obtain a respective corrected unbalancing value for each one of the fuel injectors;
compare each of the corrected unbalancing values with a predetermined threshold value thereof; and
identify a faulty fuel injector when the corresponding corrected unbalancing value exceeds the predetermined threshold value.

16. The control apparatus according to claim 15, wherein the computer program stored in the data carrier, which when executed on the electronic control unit, is further configured to determine the predetermined threshold as a function of an engine working point.

17. The control apparatus according to claim 15, wherein the computer program stored in the data carrier, which when executed on the electronic control unit, is further configured to identify a faulty fuel injector when the corresponding corrected unbalancing value exceeds the predetermined threshold for a predetermined amount of time.

18. The control apparatus according to claim 15, wherein the computer program stored in the data carrier, which when executed on the electronic control unit, is further configured to:
multiply each of the corrected unbalancing values by a respective factor to obtain a diagnostic unbalancing value; and
identify a faulty fuel injector when the corresponding diagnostic unbalancing value exceeds the predetermined threshold.

19. An automotive system comprising the control apparatus according to claim 15.
